(19) United States
(12) Patent Application Publication
(10) Pub. No.: US 2002/0089657 A1
(43) Pub. Date: Jul. 11, 2002

(54) Stage devices configured for use in a vacuum environment of a charged-particle-beam microlithography apparatus

(75) Inventor: Yukiharu Okubo, Kumagaya-shi (JP)

Correspondence Address: KLARQUIST SPARKMAN, LLP, One World Trade Center, Suite 1600, 121 S.W. Salmon Street, Portland, OR, 97204, US

(73) Assignee: Nikon Corporation

(21) Appl. No.: 10/008,689

(22) Filed: Nov. 8, 2001

(30) Foreign Application Priority Data
Nov. 8, 2000 (JP) 2000-340748

(51) Int. Cl. G03B 27/62

(52) U.S. Cl. 355/76; 355/73; 355/53; 310/10; 310/12

(57) ABSTRACT

Stage devices are disclosed for use especially in a vacuum environment as encountered in a charged-particle-beam (CPB) microlithography (exposure) apparatus. An embodiment of the stage device includes a bottom plate that serves as a guide plate providing two opposing parallel edge planes that serve as respective guide planes. A top plate and a moving table are sandwiched between the guide planes. Extending from one edge of the moving table is a sample platform desirably configured to carry at least two objects such as two reticles or two wafer substrates. Between the top surface of the bottom plate and the bottom surface of the top plate are air pads that provide near frictionless motion of the moving table relative to the guide planes. The moving table is provided with multiple (e.g., three) linear motor coils that provide motion of the moving table in two dimensions relative to the guide planes (e.g., X and Y directions) as well as about an axis extending orthogonally to the guide planes (θ-direction motion).

### FIELD

This disclosure pertains to microlithography, which is a key technique used in the manufacture of microelectronic devices such as integrated circuits, displays, thin-film magnetic pickup heads, and micromachines. Microlithography generally involves the imaging of a pattern, usually defined by a reticle or mask, onto a surface of a substrate having a layer (termed a “resist”) imprintable with the image in a manner similar to photography. More specifically, this disclosure pertains to microlithography performed using a charged particle beam as an energy beam, and even more specifically to stage devices for accurately and precisely moving objects such as reticles and substrates in a charged-particle-beam microlithography system.

### BACKGROUND

Various types of stage devices have been developed for achieving accurate and precise movement and positioning of objects such as reticles and substrates in a charged-particle-beam (CPB) microlithography system.

A first example of a conventional stage device, as disclosed in Japan Kókai Patent Document No. Sho 62-182692, is a two-axis air-stage device including a box-like gas bearing (e.g., air bearing). An oblique view of this stage device 140 is shown in FIG. 7. The stage device 140 includes a base plate 141. Mounted to the base plate 141 are a pair of parallel base guides 142 each having a box-shaped profile. Mounted to the “inner” surface of each base guide 142 is a respective permanent-magnet plate, thereby forming respective motor yokes 142a. A respective coil bobbin 143, having a box shape, is engaged with the “upper” portion of each base guide 142. Each of the motor yokes 142a and respective coil bobbins constitutes a respective linear motor, wherein the coil bobbins 143 move in the X direction.

Extending between the coil bobbins 143 in the Y direction is a moveable guide 144 having a box-shaped configuration. Mounted to the “inner” surface of the movable guide 144 is a respective permanent magnet plate, thereby forming a respective motor yoke 144a. A coil bobbin 145, having a box shape, is engaged with the “upper” portion of the movable guide 144. The motor yoke 144a and respective coil bobbin 145 constitutes a respective linear motor, wherein the coil bobbin 145 moves in the Y direction. A stage 146 is mounted on the coil bobbin 145 for carrying a substrate or reticle.

Air-ejection holes (not shown) are provided in the inner surfaces of each of the coil bobbins 143, 145 at respective locations facing the respective motor yokes 142a, 144a. Air (or other gas) discharged from the air-ejection holes into respective gaps between the coil bobbins 143, 145 and respective motor yokes 142a, 144a forms a respective gas bearing.

The stage device 140 is structured such that there is one axis (base guide 142 and coil bobbin 143) along which a guide moves, with one additional axis (movable guide 144 and coil bobbin 145) superimposed on this. That is, the stage device 140 has a so-called “superimposed” structure in which one movable axis is superimposed on another movable axis. However, the lower movable axis is excessively large, and cannot be used in a vacuum chamber because no means is provided for recovering the gas discharged from the air bearings.

A second example of a conventional stage device 150 is disclosed in Published PCT Patent Document No. WO 99/66221, directed to a one-axis vacuum air-stage device provided with an air-bearing pad on the moving-body side. A sectional view of such a stage device is shown in FIG. 8, and an oblique partial tilt-away view is provided in FIG. 9. The stage device 150 is mounted on an installation surface G such as a surface plate or the like. At the left and right of the depicted stage device 150 are two channel-shaped movable-axis fixed members 152, installed each other, via support members 155. A movable member 153 extends between the two fixed members 152, but with a small gap therebetween. As will be described in detail below, the fixed members 152 and movable member 153 collectively constitute an air bearing. A stage 161 is mounted to an “upper” surface of the movable member 153. The stage 161 is depicted carrying a wafer 163. A movable member 156, including a “downward”-extending projection is mounted to an “under” surface of the movable member 153. Meanwhile, a fixed member 157 (having a channel-like section) is situated along a center line of the installation surface G of the stage device 150. The movable member 156 and the fixed member 157 inter-engage with each other with a defined gap therebetween, thereby constituting a linear motor. Riding on the movable member 156, the movable member 153 moves in directions perpendicular to the plane of the page (i.e., moves in the Y direction).

A portion of one of the air bearings shown in FIG. 8 is shown in FIG. 9. The depicted air bearing comprises the fixed member 152 mounted to the installation surface G and the movable member 153 sliding inside the channel defined by the fixed member 152. The fixed member 152 comprises a “top” portion 152a, a “side” portion 152b, and a “bottom” portion 152c. In FIG. 9 the portions 152a and 152b are shown opened away from respective regions indicated by broken lines.

A respective air pad 153a is provided at the “top” and “side” of the depicted portion of the movable member 153. Each air pad 153a includes a porous member. Gas is supplied to the air pad 153a from a gas-supply source 158 via a conduit 153b. A respective guard ring 153c extends around each air pad 153a.

An exhaust port 154a is provided in the top portion 152a and in the side portion 152b at respective positions facing the respective guard ring 153c. A rotary exhaust pump 159 is connected to the exhaust ports 154a via a conduit 154b. Thus, gas ejected from the air pads 153a is exhausted by the pump 159.

The movable member 153 moves in the Y direction as shown in the figure. The respective positions of the guard ring 153c at various locations in its movement range are indicated by the broken lines on the side portion 152b. As can be understood from the figure, the guard ring 153c remains in contact with the exhaust port 154a at any position in the movement range of the guard ring 153c. Thus, gas discharged from the air pad 153a is always exhausted.

The stage device disclosed in WO 99/66221 can be used in a vacuum environment. However, this stage device is only a one-axis stage. To apply the stage device to two-axis movement the one-axis stage device must be superimposed in two levels, yielding a stage device that is too large for practical use.

Also, since an individual air pad 153a is provided each of the “top” and “side,” respectively, of the moveable member 153, the number of air pads (that collectively release a substantial volume of gas into the vacuum environment) is excessive for use in many vacuum environments.

In addition, the conduit 153b is connected to the movable member 153 for supplying gas to the air pad 153a. Over the movement range of the movable member 153, the tension of the conduit 153b can exert a detrimental influence on the controllability of the movable member 153. Furthermore, whenever this one-axis stage device 150 is superimposed in two levels, a separate cable-and-conduit carrier is required for each individual axis, which undesirably increases the size and complexity of the stage device.

Japan Kókai Patent Document No. Hei 9-34135 discloses a stage device configured with an air bearing and vacuum pad to apply pressure to the table in the Z direction. An oblique view of this stage device 170 is shown in FIG. 10, and a plan view is shown in FIG. 11. The stage device 170 comprises a surface plate 171. Along opposing respective edges of the surface plate 171 are first guides 173a, 173b that extend in the Y direction, and along opposing respective edges of the surface plate 171 are second guides 174a, 174b that extend in the X direction. Respective fixed elements (including permanent magnets) 176a, 176b are disposed along the “undersides” of each of the first guides 173a, 173b, respectively. Similarly, respective fixed elements (including permanent magnets) 177a, 177b are disposed along the “upper” sides of each of the second guides 174a, 174b respectively.

A Y-guide beam 179 (movable in the Y direction) extends between the first guides 173a, 173b. A respective linear-motor coil (not shown) is provided at each end of the Y-guide beam 179. These linear-motor coils (with their respective fixed elements 176a, 176b) constitute respective linear motors. Similarly, an X-guide beam 178 (movable in the X-axis direction) extends between the second guides 174a, 174b. A respective linear-motor coil (not shown) is provided at each end of the X-guide beam 178. These linear-motor coils (with their respective fixed elements 177a, 177b) constitute respective linear motors.

A stage 181 rests on the guide beams 178, 179. The stage 181 includes, for example, an electrostatic chuck or the like used for mounting a wafer or other substrate, for example, to the stage 181.

As shown in FIG. 11, air bearings 183a, 183b, 183c, 183d are provided “beneath” the X-guide beam 178. These air bearings allow the X-guide beam 178 to be guided for motion in the X direction without actual contact of the X-guide beam with the surface of the surface plate 171. Thus, the X-guide beam 178 moves with extremely low friction in the X direction. Similarly, air bearings 184a, 184b, 184c, 184d are provided “beneath” the Y-guide beam 179, and an air bearing 184e is provided beneath the center of the surface plate 171. The load in the center of the Y-guide beam 179 is supported by the surface plate 171, so the rigidity (and hence the mass) of the Y-guide beam 179 is decreased. Also, three air bearings 185a, 185b, 185c are provided “beneath” the stage 181. These air bearings allow the load applied to the stage 181 to be supported directly by the surface plate 171, resulting in an effective increase in the rigidity of the stage.

The stage device 170 utilizes an air bearing and vacuum pad in the surface plate 171 to apply pressure to the moving table in the Z direction. In this device the weight of the moving table is received by the surface plate 171, and the pressure mechanism is simple. Hence, it is possible to configure this stage device with less mass than the stage device disclosed in Japan Kókai Patent Document No. Sho 62-182692. Unfortunately, however, the stage device 170 cannot apply pressure using a vacuum in a vacuum environment. It is possible that pressure could be applied using magnetic attraction instead of a vacuum, but such a scheme would be difficult to employ in a CPB exposure apparatus, which vulnerable to perturbations of beam trajectory by external magnetic fields.

### SUMMARY

The disadvantages and shortcomings of conventional stage devices as summarized above are addressed by the present invention, which provides, inter alia, stage devices that exhibit improved controllability as well as suitability for use in a vacuum environment.

In an embodiment of a stage device, a guide plate defines two opposing parallel guide planes facing each other across an intervening space. Each guide plane defines at least one respective gas bearing. A moving table is situated in the space between the guide planes. The moving table is configured so as to be separated from the respective guide planes by gas discharged from the respective gas bearings. The moving table is actuatable for movement in two dimensions in a movement plane (typically an X-Y plane) parallel to the guide planes and for movement about an axis orthogonal to the guide planes.

Desirably, the moving table is actuated in a manner by which movement force is applied to the center of gravity of the moving table. Such a configuration allows the moving table to be moved and positioned accurately and precisely at high velocity.

With such a configuration, guide axes of the stage device are not superimposed on each other. The gas bearings apply an equal bearing force to the moving table, between the two guide planes, in both dimensions in the movement plane. This allows the moving table to moves smoothly and with substantially zero friction in the movement plane between the guide planes. This configuration also eliminates the necessity to connect gas-supply and vacuum conduits to the moving table, allowing the size and mass of the moving table to be reduced correspondingly.

Eliminating the need to connect conduits to the moving table also removes from the moving table the deformation resistance of such conduits, which otherwise could apply substantial resistance to movement of the moving table. Thus, movement and positioning of the moving table can be performed with high accuracy and precision at high velocity.

The stage device can further include at least one respective linear motor for movement of the moving table in each of the two dimensions relative to the guide planes. Each linear motor comprises a respective movable element, coupled to the movable table, that is drivable in the movement plane. At least one of the linear motors can be situated outside the two guide planes.

The moving table can have attached thereto a cable carrier configured to have degrees of freedom of movement in the two dimensions of the guide planes as the moving table moves in the movement plane, and about the axis orthogonal to the guide planes. Thus, a single cable carrier can be used rather than multiple cable carriers attached to the moving table.

Another embodiment of a stage device includes a first plate defining a first guide plane and a second plate situated relative to the first plate and defining a second guide plane parallel to the first guide plane. A moving table is situated between the first and second guide planes. Respective gas bearings are situated in each of the first and second guide planes and are configured to discharge gas against a respective opposing surface of the moving table so as to separate the moving table from the respective guide planes while allowing the moving table to be moved relative to the first and second plates in a movement plane parallel to the first and second guide planes. The stage device also includes at least one first-direction linear motor coupled to the moving table and configured to move the moving table in a first dimension, in the movement plane, relative to the first and second plates. The stage device also includes at least one second-direction linear motor coupled to the moving table and configured to move the moving table in a second dimension, in the movement plane and perpendicular to the first dimension, relative to the first and second plates.

The stage device can also include two second-direction linear motors, wherein differential actuation of the two second-direction linear motors provides the moving table with θ-direction motion about an axis perpendicular to the guide planes.

The moving table can further include a sample platform extending outward relative to the first and second guide plates. The sample platform can be mounted to a box associated with the at least one first-direction linear motors. In this configuration the gas bearings in the first and second guide planes desirably discharge gas toward a respective opposing surface of the box.

According to another aspect of the invention, microlithographic exposure apparatus are provided for transferring a pattern onto a substrate. Various embodiments of such apparatus include an illumination-optical system and a projection-optical system. The embodiments also include respective embodiments of a stage device within the scope of the instant disclosure.

The foregoing and additional features and advantages of the invention will be more readily apparent from the following detailed description, which proceeds with reference to the accompanying drawings.

### BRIEF DESCRIPTION OF THE DRAWINGS

FIG. 1 is an oblique view of the overall structure of a stage device according to a first representative embodiment.

FIG. 2 is an elevational section of the stage device of FIG. 1.

FIG. 3 is a partial elevational section along the line A-A and a partial elevational section along the line B-B in FIG. 2.

FIGS. 4(A)-4(C) depict an exemplary embodiment of a cable carrier included with the first representative embodiment, wherein FIG. 4(A) is a front view, FIG. 4(B) is a side view, and FIG. 4(C) is a side view showing motion in the X direction.

FIG. 5 is an elevational section of a stage device according to a second representative embodiment.

FIG. 6 shows a charged particle beam (electron beam) exposure apparatus capable of containing a stage device in accordance with an embodiment of the present invention.

FIG. 7 is an oblique view of the conventional stage device disclosed in Japan Kókai Patent Document No. Sho 62-182692.

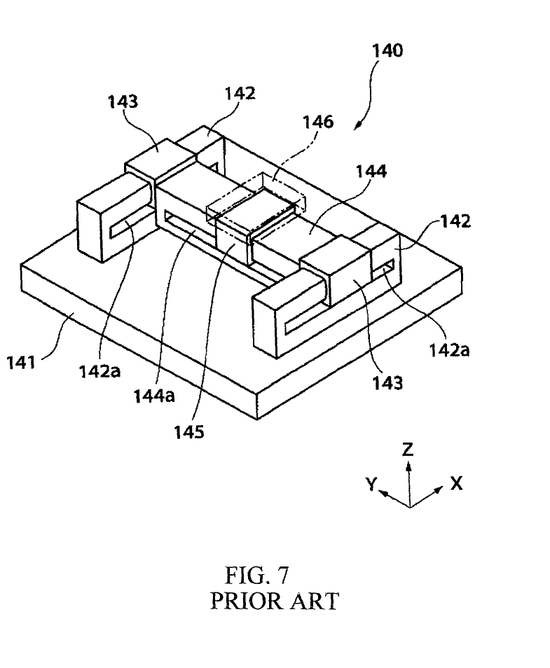

FIG. 8 is an elevational section of the conventional stage device disclosed in WO 99/66221.

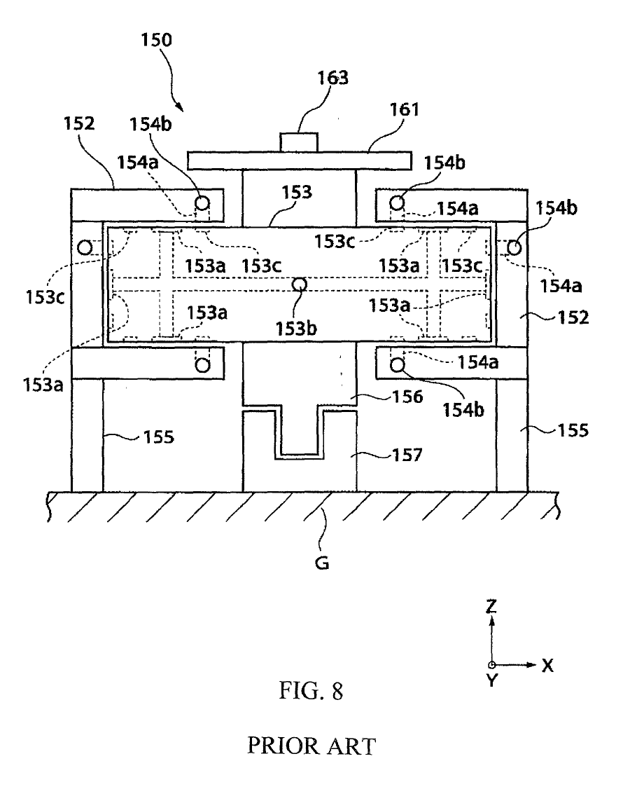

FIG. 9 is an oblique view of an air bearing of the stage device shown in FIG. 8, with certain components swung away to reveal underlying detail.

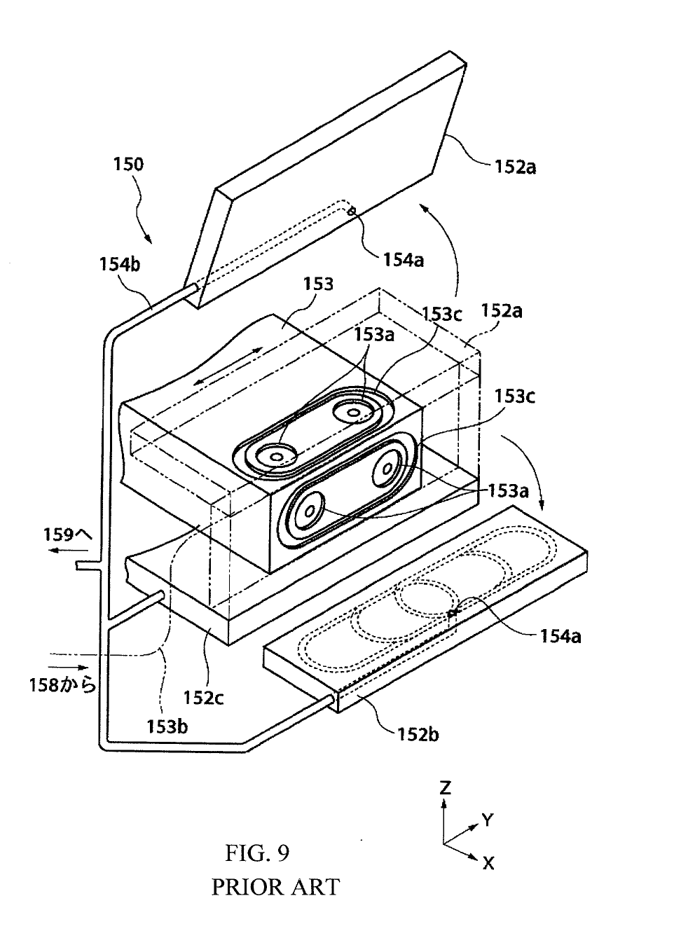

FIG. 10 is an oblique view of the conventional stage device disclosed in Japan Kókai Patent Document No. Hei 9-34135.

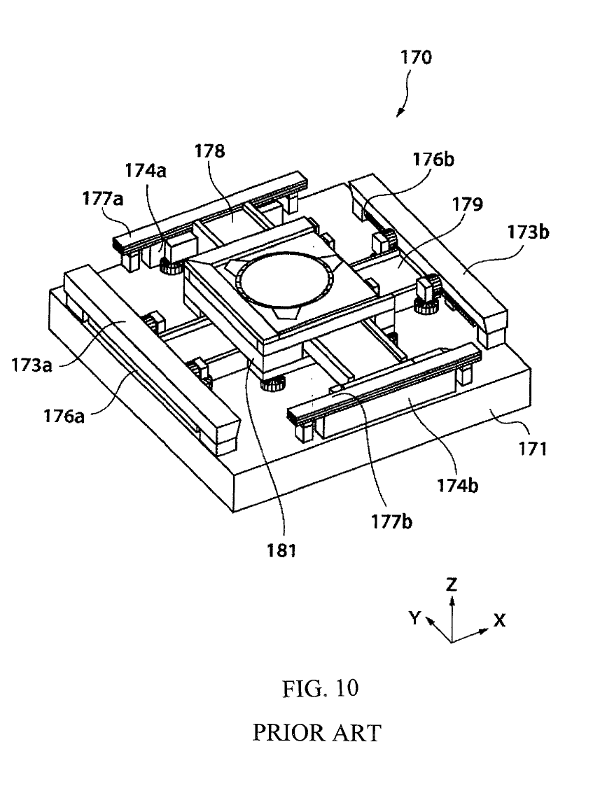

FIG. 11 is a plan view of the stage device shown in FIG. 10.

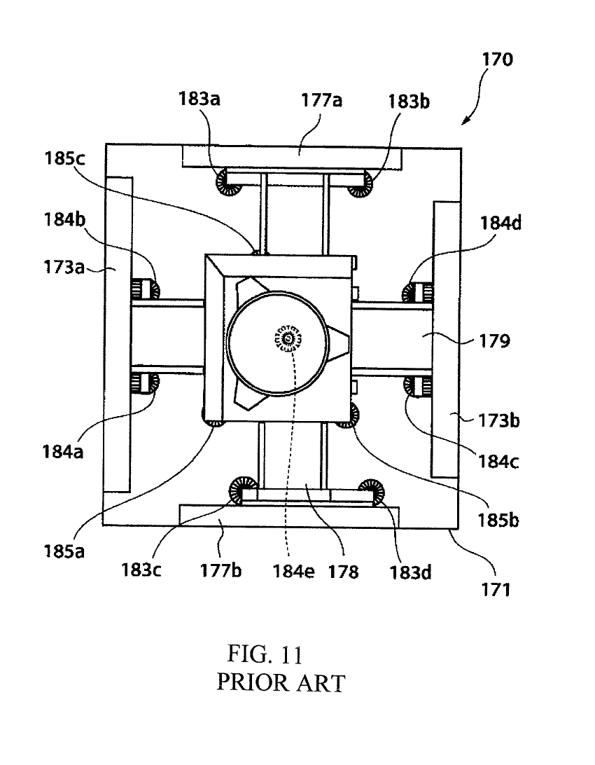

### DETAILED DESCRIPTION

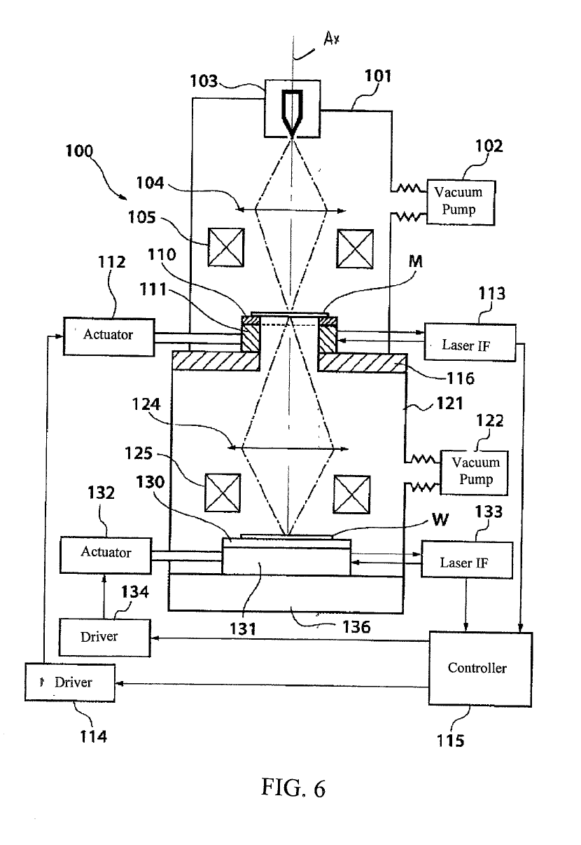

Reference is made first to FIG. 6 in the following description of a charged-particle-beam (CPB) microlithography (exposure) apparatus. The FIG.-6 embodiment utilizes an electron beam as the lithographic energy beam; however, it will be understood that the general principles of the apparatus are equally applicable to use of another type of charged particle beam, such as an ion beam. The apparatus 100 of FIG. 6 includes at least one stage device such as any of the embodiments described later below.

The apparatus of FIG. 6 comprises an optical column 101 and a wafer chamber 121 situated downstream of the optical column 101. The optical column 101 is connected to and evacuated to a predetermined vacuum level by a vacuum pump 102. At the extreme upstream end of the optical column 101 is an electron gun 103 that emits an electron beam that propagates in a downstream direction (downward in the figure) along an optical axis Ax. Situated downstream of the electron gun 103 are, in sequence, a condenser lens 104, a beam deflector 105, and a reticle M. The condenser lens 104 and beam deflector 105 constitute an “illumination-optical system” configured to illuminate selected regions of the reticle M.

The electron beam emitted from the electron gun 103 is converged by the condenser lens 104 on the surface of the reticle M. The entire reticle M is not illuminated at the same instant. Rather, the reticle M is divided into exposure units termed “subfields” each defining a respective portion of the reticle pattern. The subfields are illuminated sequentially by the beam. To such end, the beam is sequentially deflected in the appropriate lateral direction in a scanning manner by the beam deflector 105. Thus, each subfield of the reticle is brought to within the optical field of the illumination-optical system and illuminated for exposure.

The reticle M is secured to a chuck 110 mounted on an upstream-facing surface of a reticle stage 111. The chuck 110 holds the reticle by, e.g., electrostatic attraction. The reticle stage 111 rides on the base plate 116.

A reticle-stage actuator 112, shown in the figure on the left side of the optical column 101, is operably connected to the reticle stage 111. The reticle-stage actuator 112 is connected to a controller 115 via a driver 114. The reticle stage 111 also is provided with at least one laser interferometer 113. The laser interferometer 113 is connected to the controller 115. Accurate data regarding the position of the reticle stage 111 are obtained by the laser interferometer 113 and input to the controller 115. Based on these data, commands are routed from the controller 115 to the driver 114, which energizes the actuator 112 accordingly. Thus, the position and movements of the reticle stage 111 are feedback-controlled accurately and in real time.

The wafer chamber 121 is situated downstream of the base plate 116. The wafer chamber 121 defines a space that is evacuated to a desired vacuum level by a vacuum pump 122 connected to the wafer chamber 121. Situated inside the wafer chamber 121 are components of a “projection-optical system” such as a condenser lens 124 and deflector 125. Also located within the wafer chamber 121 is a lithographic substrate (termed herein a “wafer”) W.

Portions of the electron beam that pass through the reticle M thus acquire an aerial image of the illuminated portion of the reticle M, and hence are termed a “patterned beam.” The patterned beam is converged by the condenser lens 124 and deflected by the deflector 125 as required to form an image, corresponding to the aerial image, at a desired location on the upstream-facing surface of the wafer W.

During exposure the wafer W is secured to a chuck 130 mounted on the upstream-facing surface of a wafer stage 131. The wafer W is held to the chuck 130 by, e.g., electrostatic attraction. The wafer stage 131 rides on a surface plate 136.

The wafer stage 131 is driven by a wafer-stage actuator 132, shown in the figure at the left of the wafer chamber 121, operably connected to the wafer stage 131. The wafer-stage actuator 132 is connected to the controller 115 via a driver 134. The wafer stage 131 is provided with at least one laser interferometer 133 that is connected to the controller 115. The laser interferometer 133 obtains accurate positional data concerning the wafer stage 131. These data are input to the controller 115. Based on these data, the controller routes commands to the driver 134, which energizes the actuator 132 accordingly. Thus, the position and movements of the wafer stage 131 are feedback-controlled accurately and in real time.

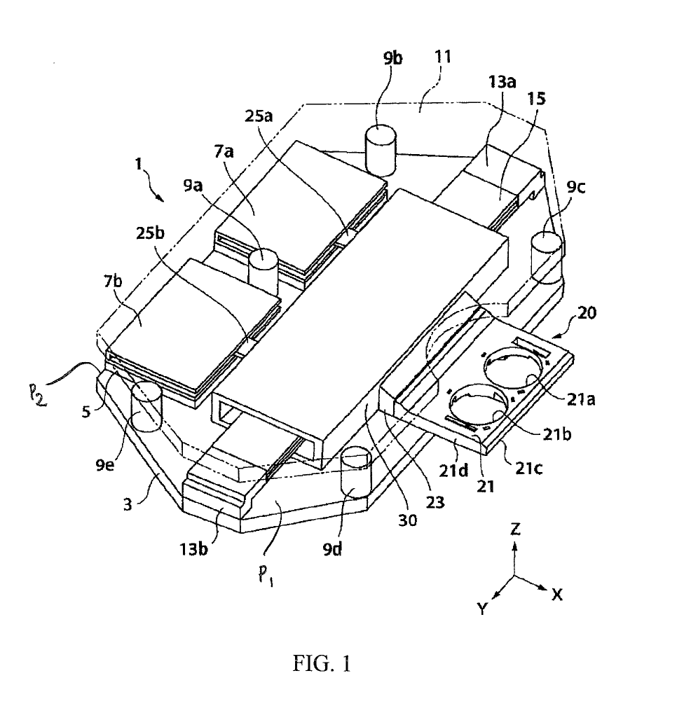

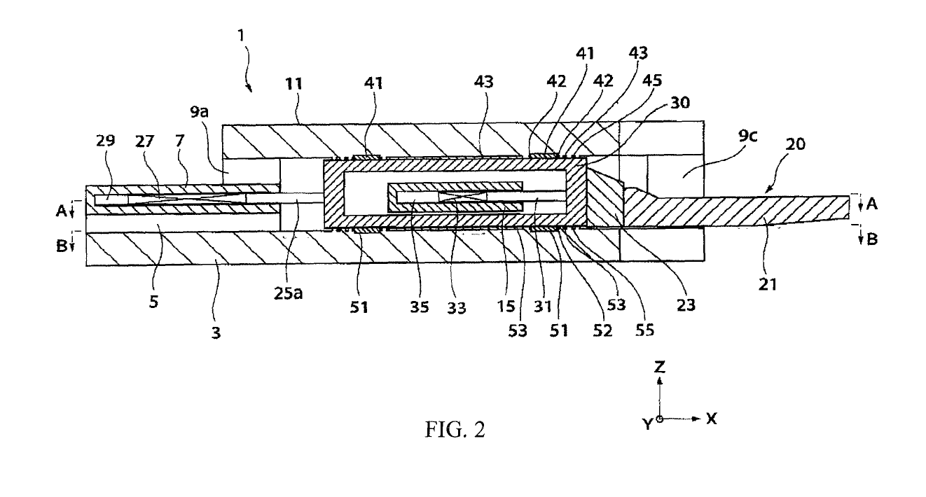

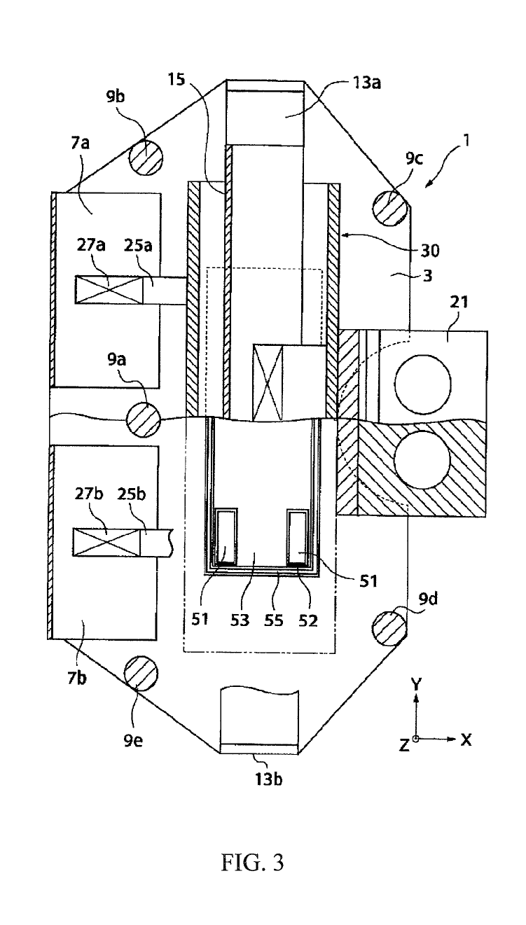

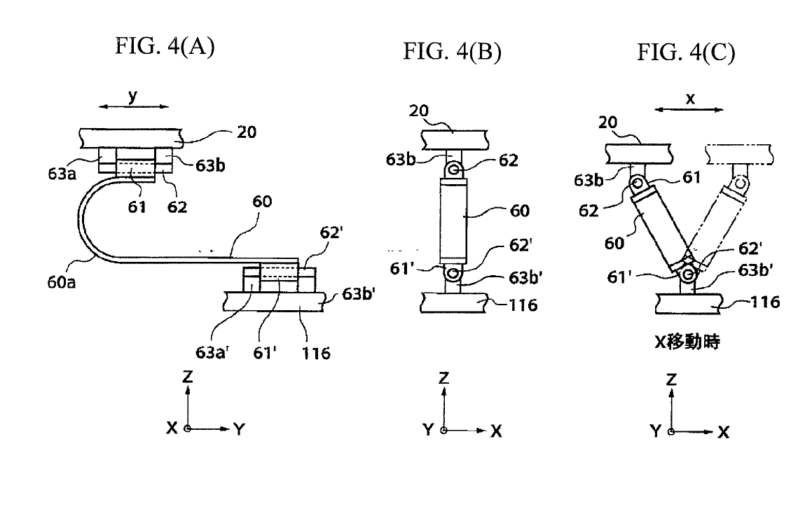

A first representative embodiment of a stage device according to an aspect of the invention is described with reference to FIGS. 1-4. FIG. 1 is an oblique view showing overall structure of the stage device; FIG. 2 is an elevational view of a portion of the stage device; FIG. 3 is an elevational section having a first portion along the line A-A in FIG. 2 and a second portion along the line B-B in FIG. 2. FIGS. 4(A)-4(C) depict the cable carrier used in this embodiment, wherein FIG. 4(A) is a front view, FIG. 4(B) is a side view, and FIG. 4(C) depicts motion in the X direction. The “front” of the subject stage device is to the right in FIGS. 1, 2, and 3, and the “rear” is to the left in FIGS. 1, 2, and 3. “Left” is diagonally downward to the left in FIGS. 1 and 3, and “right” is diagonally upward to the right in FIGS. 1 and 3. Hence, the forward/backward direction is the X axis, the left/right direction is the Y axis, and the up/down direction (the up/down direction in FIG. 2) is the Z axis.

The stage device 1 of this embodiment is described below as if it corresponded to the reticle stage 111 in the system of FIG. 6. Alternatively, the stage device 1 can be used as the wafer stage 131 in the system of FIG. 6, for example. Further alternatively, a CPB microlithography apparatus can include two stage devices 1, one for holding the reticle and the other for holding the wafer.

The stage device 1 includes a bottom plate 3 and a top plate 11. The bottom plate 3 and top plate 11 effectively serve as a “guide plate” that defines two guide planes P₁ (on the top surface of the bottom plate 3) and P₂ (on the bottom surface of the top plate 11) facing each other across a space defined by the Z-direction distance between the planes P₁, P₂. The stage device 1 also includes a “top” plate 11 (depicted in phantom in FIG. 1) and a moving (sliding) table 20 sandwiched between the bottom plate 3 and the top plate 11. A sample platform 21, capable of carrying two reticles, forms a frontward extension of the moving table 20. Air pads 41 and 51 are defined in the top surface of the bottom plate 3 and in the bottom surface of the top plate 11, respectively (FIG. 2). Three linear-motor coils 27a, 27b, and 33 are associated with the moving table 20. Thus, the moving table 20 is drivable in two directions (X direction, Y direction) and about an axis orthogonal to the guide planes (θ-direction motion) between the guide planes P₁, P₂.

The bottom plate 3 extends in the XY plane, and is configured as a planar, desirably eight-sided member that is elongated to the left and right, and that has a defined thickness. The top surface of the bottom plate 3 serves as a guide surface for guiding motion of the moving table 20 in the X-Y plane. Gas bearings are formed in the upper surface of the bottom plate 3, as described later below. Although not shown, a vacuum conduit (as well understood in the art) is connected to each of the gas bearings in the bottom plate 3.

Mounted rearward on the upper surface of the bottom plate 3 is a mounting plate 5, desirably rectangular in shape. Attached to the upper surface of the mounting plate 5, as shown in FIG. 1, are two permanent magnets 7a, 7b that are aligned with each other and separated from each other by a defined distance in the left/right direction. Each of the magnets 7a, 7b desirably is rectangular in profile with a flat box-like shape. The magnets 7a, 7b are secured to the mounting plate 5 with their respective openings facing frontward. The height of each magnet 7a, 7b is adjusted using the mounting plate 5. As described later below, the magnets 7a, 7b form respective linear motors that are arranged relative to each other so as to drive the center of gravity of the moving table 20.

A column 9a is situated between the magnets 7a, 7b and mounted vertically on the bottom plate 3. Similarly, columns 9d and 9c are respectively mounted at the left and right comers of the front of the bottom plate 3, and a column 9b is mounted behind the column 9c on the bottom plate 3. Yet another column 9e is mounted behind the column 9d on the bottom plate 3. The top plate 11 is mounted to these five columns 9a-9e. In FIG. 1 the top plate 11 is shown in phantom for improved clarity of underlying detail.

Gas bearings are provided in the lower surface of the top plate 11, as described later below. Furthermore, although not shown, a vacuum conduit (as well understood in the art) is connected to the top plate 11 to provide vacuum exhaust to the gas bearings.

A first magnet support 13a is mounted to the bottom plate 3 between the columns 9b and 9c, and a second magnet support 13b is mounted to the bottom plate 3 between the columns 9d and 9e. A linear permanent magnet 15, extended in the left/right direction, is mounted to and extends between the magnet supports 13a, 13b .

The Z-X section of the magnet 15 has a flat box shape, with an opening facing frontward.

The moving table 20 is situated between the bottom plate 3 and the top plate 11 in the stage device 1. The sample platform 21 of the moving table 20 extends frontward in a cantilever manner. Thus, an electron beam illuminating a reticle mounted on the sample platform 21 is not blocked by the stage device 1. The sample platform 21 defines two circular holes 21a, 21b each configured to carry a respective reticle placed over it. The sample platform 21 also has a front edge 21c and side edge 21d that are polished to high precision and utilized as reflective surfaces for light from and detected by the laser interferometer 113 (FIG. 6). Although in this embodiment only one sample platform is provided (extending frontward), it will be understood that respective sample platforms can be mounted so as to extend sideways from the moving table 20.

A right-angled parallelepiped box 30 is connected to the rear of the sample platform 21 via a connecting member 23. The connecting member 23 desirably is tapered in X-Z cross-section and made of a rigid material such as ceramic or metal. The connecting member 23 serves to house wiring extending between the sample platform 21 and the box 30 and to block conduction of heat between the sample platform 21 and the box 30. The box 30 is configured as a hollow box defining respective openings to the left and right. As shown in FIG. 2, a Y-coil mounting 31, configured as a flat rectangular plate, projects from the front side wall inside the box 30. A rectangular Y-motor coil 33 is mounted to the distal end of the Y-coil mounting 31. The Y-motor coil 33 extends into the opening of the magnet 15, with gaps therebetween in the Z direction. The Y-motor coil 33 and magnet 15 collectively define a respective linear motor for Y-direction motion. Also, a space is left between the distal end of the Y-motor coil 33 and the opposing interior surface of the magnet 15 so as to provide a gap 35 in the X direction. The gap 35 defines the range of motion of the moving table 20 in the X direction. Thus, in this embodiment a linear motor drivable in the Y direction is disposed substantially at the center of the moving table 20. As a result, drive power is applied to the center of gravity of the moving table 20, thereby allowing motions and positions of the moving table 20 to be controlled with high accuracy and precision at high velocity.

X-coil connecting members 25a, 25b, each desirably configured as a rectangular flat plate, extend rearward from the box 30 near the left and right ends of the box, respectively (FIG. 3). A respective rectangular X-motor coil 27a, 27b is mounted to the distal end of each connecting member 25a, 25b. Each X-motor coil 27a, 27b extends into the open channel of the respective permanent magnet 7a, 7b (FIG. 1), leaving a respective gap in the Z direction. Thus, the X-motor coils 27a, 27b and respective magnets 7a, 7b form respective linear motors for driving the moving table 20 in the X direction.

A respective space between the end of each respective X-motor coil 27a, 27b and the interior surface of the respective magnet 7a, 7b provides a respective gap 29 in the X direction. The gaps 29 define the range of motion of the moving table 20 in the X direction. Also, the magnets 7a, 7b have sufficient width in the Y direction relative to the X-motor coils 27a, 27b to provide the X-motor coils 27a, 27b with a degree of freedom in the Y direction as well.

As indicated above, the stage device 1 drives the moving table 20 in the X-Y plane by respective motions of the Y-motor coil 33 and X-motor coils 27a, 27b. Also, because two X-motor coils 27a, 27b are provided, rotational (θ-direction) motion of the moving table 20 is achieved by varying the balance of respective propulsion forces applied by the left and right X-motor coil 27a, 27b. Also, by adjusting the balance of propulsion forces applied by the X-motor coils 27a, 27b when driving in the Y direction using the Y-motor coil 33, it is possible to perform accurate driving of the movable table 20 with little positional error.

Although not shown in FIGS. 1-3, it will be understood that electrical wires and the like necessary for actuating the motor coils 27a, 27b, 33 are attached to the moving table 20. The electrical wires extend away from the moving table 20 via a cable carrier described below with reference to FIGS. 4(A)-4(C).

The upper portion of each of FIGS. 4(A) and 4(B) depicts a portion of the moving table 20. A pair of brackets 63a, 63b are mounted to the under-surface of the moving table 20. Each bracket 63a, 63b defines a respective circular hole extending in the Y direction. A cylindrical shaft 62 extends through the holes and extends between the brackets 63a, 63b. A rotary member 61 (also having a cylindrical shape) is journaled the shaft 62 between the brackets 63a, 63b. A gap is provided between the rotary member 61 and the shaft 62 that allows the rotary member 61 to rotate relative to the shaft 62. A cable carrier 60 is connected to the underside of the rotary member 61. The cable carrier 60 is configured so as to loop back in a J shape, with a semicircular portion 60a situated at the left in the figure (FIG. 4(A)). A second rotary member 61′ (also having a cylindrical shape) is mounted beneath the cable carrier 60. The second rotary member 61′ is journaled on a second shaft 62′ (with a respective gap provided) in a manner allowing rotation of the second rotary member 61′ relative to the second shaft 62′. The ends of the second shaft 62′ are supported by respective brackets 63a′, 63b′. The base plate 116 is situated beneath and mounted to the brackets 63a′, 63b′.

Whenever the moving table 20 moves in the Y direction, the operation of the cable carrier 60 is the same as that of a conventional cable carrier. I.e., as the cable carrier 60 is pulled left or right by the moving table 20, the semicircular part 60a moves correspondingly left or right (i.e., the position of the loopback portion of the cable carrier changes). This enables the moving table 20 to move in the Y direction without deforming or pulling electrical wires and the like carried by the cable carrier 60.

The cable carrier 60 differs from a conventional cable carrier as follows: Whenever the moving table 20 moves in the X direction, as shown in FIG. 4(C), the rotary members 61, 61′ rotate around their respective shafts 62, 62′. In FIG. 4(C), whenever the moving table 20 moves from the position indicated by the solid lines at the left-hand portion of the figure to the position indicated by the broken lines at the right-hand portion of the figure, the moving table 20 remains parallel to the base plate 116. Also, the distance (in the Z direction) between the shafts 62, 62′ change, with a corresponding change in the curvature of the semicircular part 60a of the cable carrier 60. As a result of these accommodating changes in the cable carrier 60, the moving table 20 moves smoothly in the X direction without deforming or pulling the electrical wires and the like carried by the cable carrier.

As will be understood from the foregoing discussion, the cable carrier 60 allows free movement of the moving table 20 in both the X direction and the Y direction independently. Therefore, the cable carrier 60 also can allow free movement of the moving table 20 about an axis orthogonal to the guide planes (i.e., θ-direction motion) in combination with the two-axis (X and Y) movement.

This representative embodiment utilizes deflection of the cable carrier 60 to accommodate motion of the moving table 20 in the Y direction, and utilizes rotation of the shafts 62, 62′ to accommodate motion of the moving table 20 in the Y direction. Alternatively, the opposite accommodations are possible. It is also possible for the X and Y axes to be oriented at an incline rather than strictly horizontal.

Also, in this embodiment, the rotary members 61, 61′ rotate about the shafts 62, 62′, respectively. Alternatively, it is possible for the shafts 62, 62′ to be journaled in and thus rotate relative to the brackets 63a and 63b, 63a′ and 63b′, respectively. In the latter instance, locking rings or analogous fasteners desirably are attached to the shafts 62, 62′ to prevent the respective ends of the shafts from slipping out of the respective brackets.

It will be understood that the cable carrier 60 may be used environments that are not at subatmospheric pressure (“vacuum”).

The gas bearings formed in the bottom plate 3 and in the top plate 11 are now described with reference to FIGS. 2 and 3. The upper part of FIG. 3 shows the section along the line A-A in FIG. 2, and the bottom part of FIG. 3 shows the section along the line B-B in FIG. 2.

Referring to FIG. 2, multiple air pads 41 (desirably rectangular in profile) are defined in the bottom surface of the top plate 11, and multiple air pads 51 (desirably rectangular in profile) are defined in the top surface of the bottom plate 3, in the movement range of the box 30 relative to these plates. Actually, in this embodiment four each of the air pads 41, 51 are provided, even though FIG. 2 shows only two relative to each plate 11, 3. Each air pad 41 and 51 comprises a respective porous member, and functions as a respective gas bearing by discharging a suitable gas (e.g., air) from the respective porous member. The discharged gas applies a pressure to opposing surfaces of the box 30 and thus defines a certain gap between the air bearing and the opposing surface of the box 30.

As shown in FIG. 3, a respective “atmospheric” guard ring 52 (configured as a respective groove defined in the top surface of the bottom plate 3) surrounds each air pad 51 and is used for collecting discharged gas and for discharging the collected gas to the atmosphere. Surrounding all four air pads 51 and their respective atmospheric guard rings 52 is an “LV” (low vacuum) guard ring 53 (configured as a respective groove defined in the top surface of the bottom plate 3) used for applying a low vacuum (e.g., about 10⁻¹ Torr) outside the atmospheric guard rings 52. A HV (high vacuum) guard ring 55 (configured as a respective groove defined in the top surface of the bottom plate 3) is situated outside the LV guard ring 53 and is used for applying a high vacuum (e.g., about 10⁻³ Torr) outside the LV guard ring 53. In a similar manner, a respective atmospheric guard ring 42 surrounds each of the air pads 41, and an LV guard ring 43 and HV guard ring 45 surrounds the atmospheric guard rings 42 and air pads 41. These guard rings 42, 43, 45 are defined as respective grooves in the bottom surface of the top plate 11.

If the stage device 1 is used in a vacuum environment, the area around the stage device must be kept at a high vacuum and gas leaks from the gas bearings into the vacuum environment must be minimized. To such end, gas discharged from the air pad 51 applies pressure to the opposing surface of the box 30. The discharged gas then enters the atmospheric guard ring 52 for venting to the atmosphere. Gas leaking past the atmospheric guard ring 52 is collected by the LV guard ring 53. Gas leaking past the LV guard ring 53 is collected by the HV guard ring 55. Thus, efficient and effective scavenging of discharged gas is achieved.

The LV guard rings 43, 53 are configured to surround the respective four air pads 41, 51 and respective atmospheric guard rings 42, 52 entirely. With such a configuration, almost none of the gas discharged from the air pads 41, 51 is applied directly to the respective opposing surface of the box 30, thereby eliminating deformation of the box 30. For similar reasons, the HV guard rings 45, 55 are configured to surround the respective LV guard rings 43, 53 entirely.

The HV guard rings 55 defined in the bottom plate 3 and top plate 11 encompass a dimensional range narrower than corresponding dimensions of the box 30 itself. Otherwise, whenever the box 30 moves sufficiently to uncover an HV guard ring for example, gas would leak into the vacuum environment. Therefore, the actual movement range of the moving table 20 is from the end of the box 30 to the periphery of the HV guard ring 55.

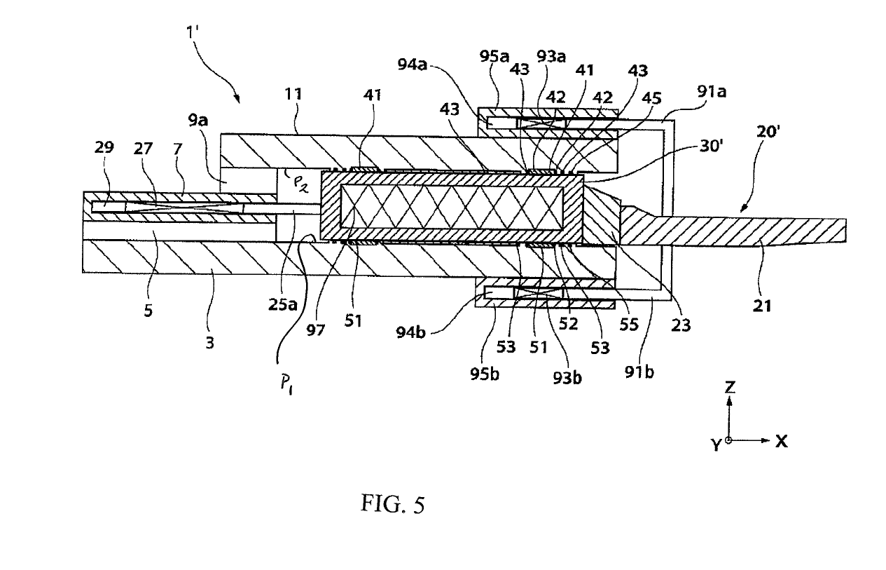

A second representative embodiment of a stage device 1′ according to an aspect of the invention is now described with reference to FIG. 5, depicting an exemplary elevational section. As in the first representative embodiment, the stage device 1′ comprises a moving table 20′ sandwiched between a bottom plate 3 and a top plate 11. In this embodiment the gas bearings defined in the plates 3, 11 have the same respective structures as in the first representative embodiment.

In the embodiment of FIG. 5, magnets 95a, 95b (constituting respective linear motors for Y-direction driving) are disposed above and below, respectively, the top plate 11. Each of the magnets 95a, 95b has a flat, rectangular box-shaped configuration, with respective openings oriented frontward.

As in the first representative embodiment, the moving table 20′ is provided with (in sequence from the front) a sample platform 21, a connecting member 23, a box 30′, X-coil connecting members 25a, 25b, and X-motor coils 27a, 27b.

The interior of the box 30′ differs from the first representative embodiment in that the embodiment of FIG. 5 lacks a Y-coil connecting member and a Y-motor coil. The embodiment of FIG. 5 includes L-shaped Y-coil connecting members 91a, 91b extending upward and downward, respectively from the sample platform 21. Respective rectangular Y-motor coils 93a, 93b are mounted to the distal ends of the respective Y-coil connecting members 91a, 91b. The Y-motor coils 93a, 93b extend into the respective openings of the magnets 95a, 95b, with respective gaps provided in the X direction. The Y-motor coils 93a, 93b and magnets 95a, 95b thus form respective linear motors for Y-direction driving of the moving table 20′. Also, the distal end of each Y-motor coil 93a, 93b and the opposing interior face of the respective magnet 95a, 95b are situated so as to define a respective gap 94a, 94b therebetween in the X direction. These gaps define the movement range of the moving table 20′ in the X direction.

X-Y driving of the moving table 20′ is achieved by actuating the Y-motor coils 93a, 93b and the X-motor coils 27a, 27b. In addition, rotational (θ-direction) motion is provided by differentially actuating the X-motor coils 27a, 27b.

By disposing Y-direction linear motors one below the other at two places, it is possible to apply a driving force to the center of gravity of the moving table 20′, thereby providing positional control of the moving table 20′ with high accuracy and high precision at high velocity.

The LV guard rings 43, 53 are configured to surround the respective four air pads 41, 51 and respective atmospheric guard rings 42, 52 entirely. With such a configuration, almost none of the gas discharged from the air pads 41, 51 is applied directly to the opposing surface of the box 30′, thereby substantially reducing deformation of the box 30′. However, at any location where discharged gas is directly applied to the box 30′, slight vertical deformation of the box 30′ could occur. To prevent such deformation, the interior of the box 30′ is provided with a reinforced core 97 (e.g., honeycomb or ribs, for example; see FIG. 5) sufficient to increase the rigidity of the box 30′. This reinforced core 97 also allows the thickness of the box 30′ in the Z direction to be reduced and the mass of the box 30′ correspondingly reduced. Reducing the thickness of the box 30′ in the Z direction also is possible because a Y-direction linear motor is not provided inside the box 30′ in this embodiment.

Whereas the invention has been described in connection with multiple representative embodiments, it will be understood that the invention is not limited to those embodiments. On the contrary, the invention is intended to encompass all alternatives, modifications, and equivalents as may be included within the spirit and scope of the invention, as defined by the appended claims.

What is claimed is:

1. A stage device, comprising:
a guide plate defining two opposing parallel guide planes facing each other across an intervening space, each guide plane defining at least one respective gas bearing;
a moving table situated in the space between the guide planes, the moving table being configured so as to be separated from the respective guide planes by gas discharged from the respective gas bearings; and
the moving table being actuatable for movement in two dimensions in a movement plane parallel to the guide planes and for movement about an axis orthogonal to the guide planes.

2. The stage device of claim 1, wherein the guide planes are parallel to an X-Y movement plane.

3. The stage device of claim 1, further comprising at least one respective linear motor for movement of the moving table in each of the two dimensions relative to the guide planes, each linear motor comprising a respective movable element, coupled to the movable table, that is drivable in the movement plane.

4. The stage device of claim 3, wherein at least one of the linear motors is situated outside the two guide planes.

5. The stage device of claim 1, further comprising a cable carrier attached to the moving table, the cable carrier being configured to have degrees of freedom of movement in the two dimensions of the guide planes as the moving table moves in the movement plane, and about the axis orthogonal to the guide planes.

6. A stage device, comprising:
a first plate defining a first guide plane;
a second plate situated relative to the first plate and defining a second guide plane parallel to the first guide plane;
a moving table situated between the first and second guide planes;
respective gas bearings situated in each of the first and second guide planes and configured to discharge gas against a respective opposing surface of the moving table so as to separate the moving table from the respective guide planes while allowing the moving table to be moved relative to the first and second plates in a movement plane parallel to the first and second guide planes;
at least one first-direction linear motor coupled to the moving table and configured to move the moving table in a first dimension, in the movement plane, relative to the first and second plates; and
at least one second-direction linear motor coupled to the moving table and configured to move the moving table in a second dimension, in the movement plane and perpendicular to the first dimension, relative to the first and second plates.

7. The stage device of claim 6, comprising two second-direction linear motors, wherein differential actuation of the two second-direction linear motors provides the moving table with θ-direction motion about an axis perpendicular to the guide planes.

8. The stage device of claim 6, wherein the moving table further comprises a sample platform extending outward relative to the first and second guide plates.

9. The stage device of claim 8, wherein the sample platform is mounted to a box associated with the at least one first-direction linear motors.

10. The stage device of claim 9, wherein the gas bearings in the first and second guide planes discharge gas toward a respective opposing surface of the box.

11. A microlithographic exposure apparatus for transferring a pattern onto a substrate, comprising:
an illumination-optical system;
a projection-optical system; and
a stage device as recited in claim 1.

12. A microlithographic exposure apparatus for transferring a pattern onto a substrate, comprising:
an illumination-optical system;
a projection-optical system; and
a stage device as recited in claim 6.
